(19) United States
(12) Patent Application Publication
(10) Pub. No.: US 2006/0036674 A1
(43) Pub. Date: Feb. 16, 2006

(54) Broadcasting network and content delivery system

(76) Inventors: Chris S. Walden, Plano, TX (US); Paul D. Nettle, Lewisville, TX (US)

Correspondence Address: MICHAEL A. O'NEIL, P.C., 5949 SHERRY LANE, SUITE 820, DALLAS, TX, 75225, US

(21) Appl. No.: 10/875,698

(22) Filed: Jun. 24, 2004

Related U.S. Application Data
(60) Provisional application No. 60/570,024, filed on May 11, 2004.

(51) Int. Cl. G06F 15/16

(52) U.S. Cl. 709/203

(57) ABSTRACT

A web server, a polling server, a client subscriber, and a plurality of media providers communicate with each other via a network. Media providers enlist the services of an Affinity Broadcast Network to provide their media content to a client subscriber. Likewise, a client subscriber contacts the Affinity Broadcast Network to subscribe for the delivery of media content from a media provider. The Affinity Broadcast Network monitors the media provider in order to determine when media content is available to be delivered to the client subscriber. When media content is available the Affinity Broadcast Network instructs the client subscriber to request the media content from the media provider and the media content is “pushed” to the client subscriber. The media providers may be located in various locations.

### FIELD OF THE INVENTION

The present invention relates generally to apparatus and methods for the delivery, management and tracking of digital media to client subscribers over a network and in particular to an Affinity Broadcast Network which enables digital media content to be pushed to any computer in a network.

### BACKGROUND OF THE INVENTION

The increased availability of high speed Internet connections is allowing for the delivery of various sorts of media from content providers. For example text, music and movies can easily be downloaded onto a user's personal computer for viewing or playback. While some content is free there are also media providers who wish to charge for their content. Providers who wish to charge for their content need to establish a billing system and maintain user accounts. Furthermore, for those media providers who make available periodic media, for example an online magazine, there needs to be a way to alert users when new media becomes available.

While each media provider can maintain individual administrative systems it is inconvenient for end users who are required to repeatedly set up an account with each individual provider. It would be beneficial therefore, to have a method and apparatus to consolidate user account information and to alert users when new media content becomes available.

### SUMMARY OF THE INVENTION

In the present invention a web server, a polling server, a client subscriber, and a plurality of media providers communicate with each other via a network. The network can be of any type but would typically be the Internet or an Intranet. In the present invention, media providers enlist the services of an Affinity Broadcast Network to provide their media content to a client subscriber. Likewise, a client subscriber contacts the Affinity Broadcast Network to subscribe to the delivery of media content from one or more media providers. The Affinity Broadcast Network monitors the media provider to which the client subscriber subscribed in order to determine when media content is available to be delivered to the client subscriber. When media content is available the Affinity Broadcast Network instructs the client subscriber to request the media content from the media provider and the media content is “pushed” to the client subscriber.

### BRIEF DESCRIPTION OF THE DRAWING

FIG. 1 is a block diagram of the operation of one embodiment of the present invention; and

FIG. 2 is a flow chart illustrating one embodiment of the present invention.

### DETAILED DESCRIPTION OF THE EMBODIMENTS

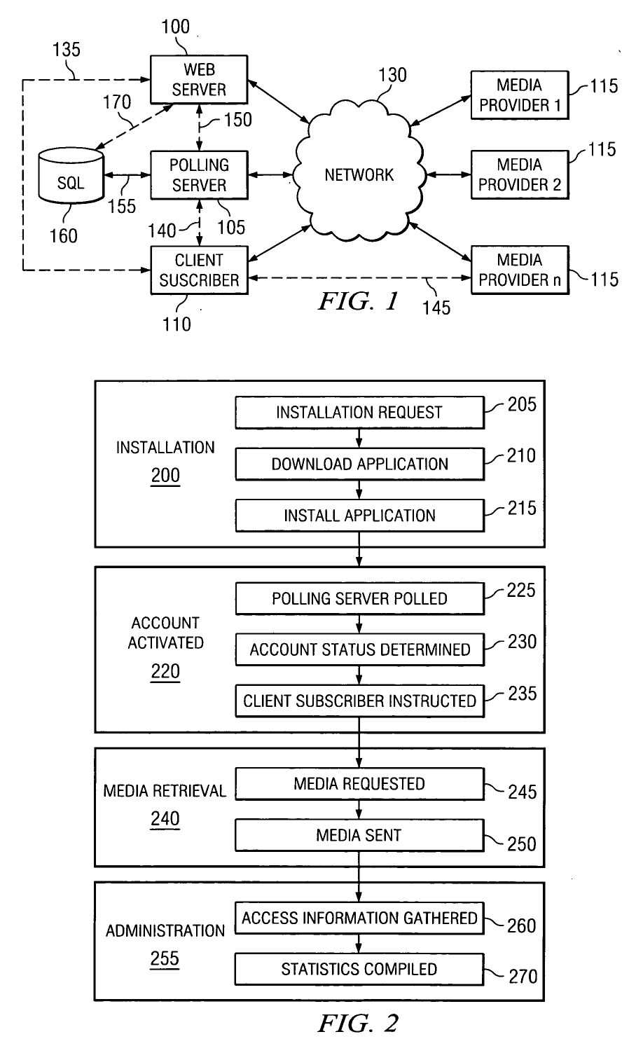

Referring now to both FIG. 1 and FIG. 2 the primary function of the present invention is illustrated. In the present invention a web server 100, a polling server 105, a client subscriber 110, and a plurality of media providers 115 communicate with each other via a network 130. The network 130 can be of any type but would typically be the Internet or an Intranet. In the present invention, media providers 115 enlist the services of an Affinity Broadcast Network to provide their media content to a client subscriber 110. Likewise, a client subscriber 110 contacts the Affinity Broadcast Network to subscribe to the delivery of media content from one or more media providers 115. The Affinity Broadcast Network monitors the media provider 115 to which the client subscriber 110 subscribed in order to determine when media content is available to be delivered to the client subscriber 110. When media content is available the Affinity Broadcast Network instructs the client subscriber 110 to request the media content from the media provider 115 and the media content is “pushed” to the client subscriber 110.

In the present invention there are four links and while all communication is performed through the network 130, FIG. 1 illustrates the paths for clarity. Each of the links 135, 140, 145 and 150 travel through the network 130. Link 135 is a connection from the client subscriber 110 to the web server 100. In a typical embodiment of the present invention the client subscriber 110 would be a personal computer. The first step of the present invention would be installation of the application software 200. The client subscriber 110 sends a request for an installation 205 to the web server 100 which is the interface for the installation of the application software. If Internet Explorer® is used as the web browser, installation is accomplished via an ActiveX installer.

Upon accessing the web server 100, an ActiveX application is downloaded 210 to the client subscriber 110 and the user is prompted with a security warning asking the user if they trust the certificate holder enough to run the ActiveX application. If the user selects “Yes”, the application software is installed 215. The application files reside in the web server 100 and can be in the form of a Microsoft® CAB file, and contain all files necessary to run the application on the client subscriber 110. Once this process is complete, the application will be installed and running on the client subscriber 110.

Once the application software is installed and running on the client subscriber's 110 personal computer, the client subscriber 110 activates the account 220 by polling 225 the polling server 105 via link 140. The polling server 105 then checks the status 230 of the account to determine if there is media content available for delivery or if any other action is to be taken and instructs 235 the client subscriber 110 as to what action is to be taken. The polling process is broken into two components, a static component which is comprised of logic and code and a dynamic component which is comprised of a database. FIG. 1 depicts a two-way link 155 between the polling server 105 and a SQL server 160. It is possible that the polling server 105 and SQL server 160 be running on the same machine. The polling server 105 acts as an interface to the SQL server 160. The static component comprising logic and code acts as this interface.

The polling server 105 communicates with the SQL server 160 to retrieve the live dynamic data which drives the polling process. This follows the traditional data-driven model of software design. When a poll is received by the polling server 105, it consults the SQL server 160 as to what instructions should be carried out as a result of the poll. The polling server 105 then sends 235 the client subscriber 110 a set of actions to be performed by the application software. These actions can be of any type and manner but typically support the particular media content of particular media provider 115.

The polling server 105 checks the status of the client subscriber's 110 account 230 and if media is waiting for the client subscriber 110 instructions will be sent 235 to the client subscriber 110 and will include information pertaining to the total size of the media available on the media provider 115, a series of URLs by which to download the individual files of the media, the location on the client subscriber 110 where that media should be stored relative to the application installation folder and an execution statement describing what should be done once the media has arrived.

By way of example the following code is provided as an illustration of a typical communication between the polling server 105 and the client subscriber 110 and shows a target file describing content delivery to the client subscriber's personal computer.

t 10272191
l NCHA Cutters Video Magazine August 2003 Preview
q http://media01.accessabn.com/media/ncha/2003-08-20-ncha-

trailer/back.jpg|˜Data\NCHA Cutters Video Magazine August 2003
Preview\back.jpg

q http://media01.accessabn.com/media/ncha/2003-08-20-ncha-

trailer/control.run|˜Data\NCHA Cutters Video Magazine August 2003
Preview\control.run

q http://media01.accessabn.com/media/ncha/2003-08-20-ncha-

trailer/mask.jpg|˜Data\NCHA Cutters Video Magazine August 2003
Preview\mask.jpg

q http://media01.accessabn.com/media/ncha/2003-08-20-ncha-

trailer/model.xyz|˜Data\NCHA Cutters Video Magazine August 2003
Preview\model.xyz

q http://media01.accessabn.com/media/ncha/2003-08-20-ncha-trailer/ncha-

trailer-082003.exe|˜Data\NCHA Cutters Video Magazine August 2003
Preview\ncha-trailer-082003.exe

q http://media01.accessabn.com/media/ncha/2003-08-20-ncha-

trailer/onstart.wav|˜Data\NCHA Cutters Video Magazine August 2003
Preview\onstart.wav

q http://media01.accessabn.com/media/ncha/2003-08-20-ncha-

trailer/shop.htm|˜Data\NCHA Cutters Video Magazine August 2003
Preview\shop.htm

q http://media01.accessabn.com/media/ncha/2003-08-20-ncha-

trailer/texture.jpg|˜Data\NCHA Cutters Video Magazine August 2003
Preview\texture.jpg

q http://media01.accessabn.com/media/ncha/2003-08-20-ncha-

trailer/video1.vid|˜Data\NCHA Cutters Video Magazine August 2003
Preview\video1.vid

q http://media01.accessabn.com/media/ncha/2003-08-20-ncha-

trailer/vPlayerX.dll|˜Data\NCHA Cutters Video Magazine August 2003
Preview\vPlayerX.dll

q http://media01.accessabn.com/media/ncha/2003-08-20-ncha-

trailer/vPlayerXRegister.exe|˜Data\NCHA Cutters Video Magazine
August 2003 Preview\vPlayerXRegister.exe

q http://media01.accessabn.com/media/ncha/2003-08-20-ncha-

trailer/content.mpd|˜Data\NCHA Cutters Video Magazine August 2003
Preview\content.mpd
z Data\NCHA Cutters Video Magazine August 2003

Preview\control.run

Each line of the target file shown above describes one of a number of actions processing initiatives to be performed by the client subscriber 110. Lines that begin with a ‘t’ are lines that describe the total size of the media. This allows the client subscriber 110 to track the overall progress of the media delivery from the media provider 115 via link 145. There should be only one ‘t’ line in a target file. Lines that begin with an ‘l’ are lines that provide the client subscriber 110 with the name of the content being downloaded. There should be only one ‘l’ line in a target file. Lines that begin with a ‘q’ are lines that provide the client subscriber 110 with a fully qualified URL specifying the location of where to get the media file, followed by a local location on the client subscriber 110 for where to store that media. During storage, folders are created as necessary. The URL and the local storage location are separated by a vertical bar (|) character allowing the client subscriber 110 to parse the line properly. The local delivery location may be in one of two forms. Either an absolute path to the file's location or a path relative to the client subscriber's 110 installation folder. These entries will begin with a tilde character which is replaced with the path to the installation folder and is not considered part of the path itself. Lines that begin with a ‘z’ are lines that provide the client subscriber 110 with an instruction for execution of the content. This instruction is performed upon complete & successful download of a piece of content. There may be many ‘z’ lines in a single delivery. The transmission of media from the media servers 115 to the client subscriber 110 is a background process on the client subscriber 110 and is performed using standard HTTP protocol on port 80.

The target information, which is sent to the client subscriber 110 by the media servers 115 is specific to a specific client. For example, a corporate customer may wish to maintain their own media server(s) 115 on their intranet 130, in order to avoid saturating their Wide Area Network interface to the Internet 130. Allowing clients to be flagged for a specific list of media servers 115, for example their internal Intranet servers 115, enables the polling server 105 to direct all media requests to those internal servers 115 rather than external servers.

After the client server 110 has polled for an action 225 and has been instructed 235 to download a media package from the media server 115 media retrieval 240 begins. The client subscriber 110 requests media 245 and the media provider 115 sends the media 250 via link 145. The media servers 115 can be located in multiple locations and simply need access to the network 130. Adding a media server 115 to the network 130 is as simple as providing a server that is accessible by the client subscriber 110 via the network 130. While in a typical media retrieval process would be from a single media provider 115, the present invention anticipates that media could be retrieved from multiple media providers 115 during a single transaction. The media providers 115 need not be located in a single physically common data center. Instead, the use of different URLs to retrieve the medial allows the media providers 115 to be located in different data centers physically distant from one another.

In order to perform administration 255 of the system, the polling server 105 gathers access information 260 and compiles statistics 270. In order for the media providers 115 to gain access to this information and other delivery status information for transaction tracking, billing, etc., a separate back-end processing system is provided by the web server 100. This service can provide various information to the media provider 115, including view events. For example, the information may contain how many times a user has viewed a piece of media, which media a user has viewed, when the user has initially installed the application software, graphs over time of online e-commerce transactions with their dollar amounts, among others. In order to access this information, the web server 100 may have access to the SQL database 160, so a connection via link 170 is established between the web server 100 and the SQL server 160. Link 170 is also used for tracking online e-commerce transactions performed by the web server 100, so that this information can be made available later to the a back-end reporting system. Link 170 may take any form available in the industry.

The applicant draws attention to the fact that the present invention may include any feature or combination of features disclosed herein either implicitly or explicitly without limitation to the scope of any definitions set out above. In view of the foregoing description it will be evident to a person skilled in the art that various modifications may be made within the scope of the invention.

What is claimed is:

1. A content delivery system for delivering content to a client subscriber comprising:
a web server for setting up a client subscriber account; and
a polling server for maintaining client subscriber account information.

2. The content delivery system for delivering content to a client subscriber as recited in claim 1, wherein the polling server comprises:
a polling server interface; and
a SQL server for performing database functions.

3. A content delivery system for delivering content to a client subscriber as recited in claim 1, further comprising a communication link to a commonly accessible communication network for each of the client subscriber, the web server and the polling server.

4. The content delivery system for delivering content to a client subscriber as recited in claim 3, further comprising:
a media provider for providing content to the client subscriber; and
a communication link to a commonly accessible communication network for the media provider.

5. The content delivery system for delivering content to a client subscriber as recited in claim 4, wherein the polling server sends commands to the client subscriber during a polling process.

6. The content delivery system for delivering content to a client subscriber as recited in claim 5, wherein the polling server identifies a media provider using a URL.

7. The content delivery system for delivering content to a client subscriber as recited in claim 5, wherein the polling server identifies a plurality of media providers using distinct URLs assigned to each media provider.

8. The content delivery system for delivering content to a client subscriber as recited in claim 7, wherein the media providers are physically located in distant locations.

9. The content delivery system for delivering content to a client subscriber as recited in claim 7, wherein the polling server sends commands to the client subscriber for the delivery of content for a single download to be delivered from more than one media provider using multiple URLs.

10. A method for delivering content to a client subscriber comprising the steps of:
installing application software on a client subscriber computer;
activating a client subscriber account;
polling a polling server to determine availability of content for delivery;
instructing the client subscriber computer to request content delivery from a media provider; and
delivering the content to the client subscriber computer from the media provider.

11. The method for delivering content to a client subscriber as recited in claim 10, further comprising the steps of:
gathering client subscriber access information from the client subscriber computer; and
storing the client subscriber access information in the polling server.

12. The method for delivering content to a client subscriber as recited in claim 11, further comprising the step of compiling statistics on subscriber access.

13. The method for delivering content to a client subscriber as recited in claim 10, wherein the step of instructing the client subscriber to request content delivery further includes the step of identifying the media provider from among a plurality of media providers using an associated URL.

14. The method for delivering content to a client subscriber as recited in claim 13, wherein the media providers are physically located in different locations.

15. The method for delivering content to a client subscriber as recited in claim 13, wherein the step of identifying the media provider includes instructing the client subscriber to request content delivery from more than one media provider for the delivery of content for a single download by identifying more than one media provider using multiple URLs

16. A method for delivering content to a client subscriber comprising the steps of:
installing application software on a client subscriber computer;
activating a client subscriber account;
polling a polling server to determine availability of content for delivery;
instructing the client subscriber computer to request content delivery from a media provider;
delivering the content to the client subscriber computer from the media provider.
gathering client subscriber access information from the client subscriber computer;
storing the client subscriber access information in the polling server.
compiling statistics on subscriber access; and
wherein the media providers are identified by a URL and are physically located in different locations.
